(19) United States
(12) Patent Application Publication
(10) Pub. No.: US 2011/0315929 A1
(43) Pub. Date: Dec. 29, 2011

(54) SOLVENT BLEND FOR REPLACEMENT OF KETONES

(76) Inventors: Rathin Datta, Chicago, IL (US); James E. Opre, Downers Grove, IL (US); Kevin L. Monti, Aurora, IL (US)

(21) Appl. No.: 12/826,239

(22) Filed: Jun. 29, 2010

(51) Int. Cl. B01F 1/00

(52) U.S. Cl. 252/364

(57) ABSTRACT

A three-part solvent composition that contains A) a C₁ to C₄ lactate ester, B) ethyl 3-ethoxy propionate and C) a C₇-C₁₂ hydrocarbon mixture is disclosed that is a homogeneous liquid at zero degrees C. A contemplated solvent blend provides performance properties that can replace toxic ketones, but does not contain any ketone groups in any of the components.

### BACKGROUND ART

Ketones are a specific group of chemicals that are used as solvents in a wide variety of applications. Simple ketones such as acetone, methyl ethyl ketone (MEK), and methyl iso-butyl ketone (MIBK) are commonly used for general cleaning and wiping solvents and sometimes as formulation ingredients for inks and coatings.

Generally however, complex ketones are used in many such formulations because they impart many desirable properties simultaneously, such as viscosity reduction, dispersion of dyes and pigments, consistent phase behavior, desirable flow characteristics, consistent drying behavior and many other properties. One such complex ketone is Isophorone (3,5,5-trimethyl-2-cyclohexen-1-one, CAS number (78-59-1)). Isophorone is manufactured by catalyzed self-condensation of acetone by a multi step process—mesityl oxide is the initial product of the aldol self-condensation. Mesityl oxide formation is followed by a Michael reaction of acetone with the mesityl oxide followed by intramolecular aldol condensation to eventually obtain the six-membered ring of isophorone. The process is complex and low yielding but because of the desirable product properties, fairly large quantities are manufactured and used.

Ketones generally have a much higher toxicity than other simpler solvents such as esters and alcohols, and complex ketones have particularly high toxicities. Isophorone for example, in tests conducted by the National Toxicology Program (NTP) has shown some evidence of carcinogenicity in male rats and equivocal evidence of carcinogenicity was noted in male mice. In repeated exposure of isophorone to rats and guinea pigs, increases in mortality, growth retardation, kidney, lung and liver toxicity and blood cell changes were observed. Hence, isophorone is considered a Hazardous Air Pollutant as well as a SARA reportable substance and many countries are banning or regulating its large-scale usage.

Furthermore, ketones especially the complex ketones, are not readily manufactured from renewable resources and given the desirability of sustainable products and processes, there is a clear need for finding suitable substitutes for such solvents.

Ethyl lactate and other lactate esters are environmentally benign, non-toxic solvents derived from renewable carbohydrates via fermentation and separation processes. Ethyl lactate for example, has very good solvent properties and a characteristic odor. Chemically, this ester has an active hydroxyl group in addition to the carboxylic ester group. Lactate esters can also be blended with other solvents to provide biosolvent blends with enhanced properties.

Other ester solvents such as ethyl 3-ethoxy propionate available from Eastman Chemical Company of Kingsport, Tenn. (CAS #763-69-9) have an ether group in addition to the carboxylic ester group. Another generally used solvent in coating formulations is a mixture of aromatic hydrocarbons (A 150 or AR 150) available from Shell Chemical Company or Exxon Mobil Company. These mixtures are a blend of aromatic compounds (>99% aromatic hydrocarbons) that fall within a range of boiling points. The primary components are C₁₀ to C₁₁ alkyl benzenes with a total range of C₇ to C₁₂ alkyl benzenes. It should be noted that AR 150 is available in grades that have very low contents of naphthalene as a low-toxicity solvent.

### BRIEF SUMMARY OF THE INVENTION

The present invention contemplates a solvent blend that can replace isophorone in a variety of applications. A contemplated blend contains three components: A) a C₁-C₄ aliphatic ester of lactic acid, B) ethyl 3-ethoxy propionate, and C) a mixture of C₇-C₁₂ hydrocarbons that includes aromatic hydrocarbons and up to about 70 weight percent aliphatic hydrocarbons and provides enhanced properties compared to each component. A contemplated mixture of C₇-C₁₂ hydrocarbons preferably has a distillation range of about 150° to about 230° C. at one atmosphere, a Tagliabue (Tag) closed cup (TCC) flash point of about 100° F. or greater, and can be substantially all (about 95% or more) aromatic compounds, or aromatics plus zero to about 70 weight percent aliphatic compounds. A mixture of about equal weights of each type of C₇-C₁₂ hydrocarbon (aromatic and aliphatic) is preferred. Each of the three ingredients (A, B and C) can itself be present at about 10 to about 80 weight percent of the total. A contemplated composition is a homogeneous liquid at zero degrees C.

Ethyl lactate is a preferred is a preferred C₁-C₄ aliphatic ester of lactic acid. Other C₁-C₄ aliphatic lactate esters include methyl lactate, n-propyl lactate, iso-propyl lactate, n-butyl lactate, iso-butyl lactate and t-butyl lactate. In preferred embodiments, the C₁-C₄ aliphatic ester of lactic acid such as ethyl lactate (EL) is present at about 50 to about 70 weight percent, the ethyl 3-ethoxy propionate (EEP) is present at about 15 to about 35 weight percent, and the C₇-C₁₂ hydrocarbon mixture (HC) constitutes about 15 to about 35 percent. More preferably, the solvent blend contains each of the three ingredients in a ratio of about 3:1:1, EL:EEP:HC.

The present invention has several benefits and advantages. One benefit of a contemplated blend is that the performance in formulations exceeds that of isophorone.

An advantage is that the solvents in the blend contain no ketone groups and thus a contemplated blend avoids the inherent physiological toxicity that many ketones display.

Another benefit is that the primary components of these blends—ethyl lactate, ethyl 3-ethoxy propionate are environmentally benign, non-toxic and are derived at least in part, from renewable resources.

Still further benefits and advantages of the present invention will be apparent to the skilled worker from the disclosure that follows.

### DETAILED DESCRIPTION OF THE INVENTION

It has been unexpectedly found that a solvent blend that contains no ketone group and that contains esters of lactic acid, particularly ethyl lactate, when blended with ethyl 3-ethoxy propionate and a mixture of hydrocarbons provides properties that permit the blend to replace a complex ketone such as isophorone in a variety of applications

Because of its toxicity, many attempts have been made to replace isophorone as a solvent in formulations with non-toxic, environmentally benign ingredients. The results, however, have not been successful. As a matter of fact the three solvent components described in this invention if tested individually, do not give good results. The unexpected result of this invention illustrates that these solvents that have a very diverse group of chemical functionalities can be successfully blended and provide not only very uniform properties but also very good performance properties in the final coatings formulations where isophorone would normally be used.

A contemplated blend contains three components: A) a C₁-C₄ aliphatic ester of lactic acid, B) ethyl 3-ethoxy propionate, and C) a mixture of C₇-C₁₂ hydrocarbons that provides enhanced properties. Each of the three ingredients (A, B and C) can be present at about 10 to about 80 weight percent of the total. A contemplated composition is a homogeneous liquid at room temperature (about 25° C.) and at zero degrees C.

Ethyl lactate is a preferred is a preferred C₁-C₄ aliphatic ester of lactic acid. Other lactate esters include methyl lactate, n-propyl lactate, iso-propyl lactate, n-butyl lactate, sec-butyl lactate, iso-butyl lactate and tert-butyl lactate.

A contemplated mixture of C₇-C₁₂ hydrocarbons (HC) can be comprised of aromatic hydrocarbons (AM) or a mixture of both aromatic and zero to about 70 weight percent aliphatic (AC) hydrocarbons. A contemplated mixture of C₇-C₁₂ hydrocarbons has a distillation range of about 150° to about 230° C. at one atmosphere, and a Tagliabue (Tag) closed cup (TCC) flash point of about 100° F. or greater, and more preferably about 150° F. or greater (>65.6° C.).

It is to be understood that commercially available aromatic hydrocarbons and aliphatic hydrocarbons are themselves typically mixtures of distillation products obtained from oil refining, and when designated “aromatic” or “aliphatic” can contain up to about 5 weight percent of the other type of solvent. Thus, a C₇-C₁₂ aromatic hydrocarbon mixture can contain up to about 5 weight percent C₇-C₁₂ aliphatic hydrocarbon, and a C₇-C₁₂ aliphatic hydrocarbon solvent can contain up to about 5 weight percent of a C₇-C₁₂ aromatic hydrocarbon. In usual practice, a commercially available C₇-C₁₂ aromatic hydrocarbon solvent contains less than about 1 weight percent C₇-C₁₂ aliphatic hydrocarbon, and a commercially available C₇-C₁₂ aliphatic hydrocarbon solvent contains less than about 1 weight percent C₇-C₁₂ aromatic hydrocarbon. The recitation “zero” as to aliphatics present in a mixture of C₇-C₁₂ aromatic hydrocarbons is intended to synonymous with the less than about 1 weight percent that can be present in a commercial C₇-C₁₂ aromatic hydrocarbon solvent.

A contemplated mixture of C₇-C₁₂ aromatic hydrocarbons is often referred to as naphtha, ligroin, petroleum ether and petroleum spirits. These materials are also further defined by the average number of carbon atoms present in their molecules and/or boiling range. Illustrative distillation ranges for a contemplated mixture of C₇-C₁₂ aromatic hydrocarbons are about 160° to about 220° C. at one atmosphere, with individual commercial products having specific boiling ranges that approximate those listed above.

One such illustrative commercial product mixture of C₇-C₁₂ aromatic hydrocarbons is sold under the name Solvesso™ 150 by Exxon Mobil Chemical Co. that has a distillation range of about 183° C. to about 207° C., a TCC flash point of 66° C., is 99 volume percent aromatics, and has a CAS Registry No. 64742-94-5. Another illustrative commercial solvent mixture is sold under the name Atosol™ 150 that is available from Total Petrochemicals USA, Inc. That product has CAS Registry No. 64742-94-5, exhibits a distillation range of about 182° C. to about 210° C., and a TCC flash point of 150° F. or greater (>65.6° C.). Illustrative ingredients listed for Atosol™ 150 are as follows:

| Component | Amount (%) |
|---|---|
| 1,2-Dimethyl-4-ethylbenzene | 10-20 |
| 1,2,3,5-Tetramethylbenzene | 10-20 |
| 1,2,4,5-Tetramethylbenzene | 5-15 |
| 1,3-Dimethyl-4-ethylbenzene | 2-10 |
| 1,3-Dimethyl-5-ethylbenzene | 2-10 |
| 1,4-Dimethyl-2-ethylbenzene | 2-10 |
| 1-Methyl-3-propylbenzene | 2-10 |
| Naphthalene | <10 |
| 1,2,3-Trimethylbenzene | 1-5 |
| 1-methyl-4-n-propylbenzene | 1-5 |
| 1,2,4-Trimethylbenzene | <2 |
| 2-Methylnaphthalene | 2 |
| 1,3-diethylbenzene | <2 |

Examining the above ingredients, it is seen that the substituents on the aromatic groups are one or more aliphatic groups. It is also noted that the naphthalene content of a contemplated C₇-C₁₂ aromatic hydrocarbon is typically and preferably less than about 10% by weight.

A contemplated C₇-C₁₂ aliphatic hydrocarbon solvent is referred to in the art as a Stoddard solvent, or mineral spirits, and contains about 30 to about 50 weight percent paraffins, about 70 to about 50 weight percent cycloparaffins and less than 1 weight percent aromatics. Each commercial supplier's product is slightly different and an individual supplier can market a number of different C₇-C₁₂ aliphatic hydrocarbon solvents.

The illustrative entries in Table 3, below, are for five different C₇-C₁₂ aliphatic hydrocarbon solvents products each having CAS Registry No. 64742-47-8 that are produced at the CITGO facility in Lamont, Ill.

TABLE 3*

| | Distillation Range | | Flash | | | | |
|---|---|---|---|---|---|---|---|
| API | ° F. (° C.) | | Point | KB | % Hydrocarbon Composition | | |
| Gravity | IBP | DP | TCC, ° F. | Value | Aromatics | Parafins | Cycloparafins |
| 50.1 | 317 | 381 | 108 | 33 | <1 | 44 | 55 |
| | (158.3) | (193.9) | | | | | |
| 49.5 | 319 | 386 | 110 | 33 | <1 | 47 | 52 |
| | (159.4) | (196.7) | | | | | |
| 44.8 | 378 | 401 | 152 | 31 | <1 | 45 | 54 |
| | (192.2) | (205.0) | | | | | |
| 44.8 | 384 | 408 | 154 | 31 | <1 | 44 | 55 |
| | (195.6) | (208.9) | | | | | |
| 41.5 | 414 | 445 | 173 | 30 | <1 | 32 | 68 |
| | (212.2) | (229.4) | | | | | |

*API Gravity can be determined using ASTM D287; IBP = initial boiling point; DP = dry point; TCC = Tag Closed Cup; KB = Kauri-butanol value determined using ASTM D1133;

In preferred embodiments, the C₁-C₄ aliphatic ester of lactic acid (EL) such as ethyl lactate is present at about 50 to about 70 weight percent, the ethyl 3-ethoxy propionate (EEP) is present at about 15 to about 35 weight percent, and the C₇-C₁₂ hydrocarbon (HC) constitutes about 15 to about 35 eight percent. More preferably, the solvent blend contains each of the three ingredients in a ratio by weight of about 3:1:1, EL:EEP:HC.

The following examples are provided to support the present invention.

### Example 1

After studying the structure and general properties if isophorone, several individual solvents were evaluated for matching physical and solvation properties and then they were mixed in certain proportions. After some comprehensive evaluations and calculations, a particularly preferred mixture was chosen. This mixture contains (wt %)—ethyl lactate (EL 60%), ethyl 3-ethoxy propionate (EEP 20%) and aromatic solvent blend (AR 150 20%), or at a ratio by weight of 3:1:1. The calculated and estimated comparative properties of isophorone and the mixture are shown in Table 1, below.

TABLE 1*

| | | | | | Hansen Solubility | | | | | |
|---|---|---|---|---|---|---|---|---|---|---|
| | Mol | BP | Evap | η | Parameters** | | | | Sp. | |
| | wt. | (° C.) | Rate | (cps) | SPo | SPd | SPp | SPh | Gr. | VP |
| Isophorone | 138 | 213 | 0.02 | 2.4 | 9.7 | 8.1 | 4.0 | 3.6 | 0.92 | 0.26 |
| Solvent ISR | 125 | 154-204 | ~0.15 | ~1.9 | 9.7 | 8.1 | 2.5 | 4.7 | 0.99 | ~1.5 |
| blend | | | | | | | | | | |
| (3EL/1EEP/1 | | | | | | | | | | |
| AR150) | | | | | | | | | | |

*Mol wt = molecular weight; BP = boiling point or range; Evap Rate = evaporation rate relative to n-butyl acetate; η = Viscosity; Hansen values: SPo = total (overall), SPd = dispersion, SPp = polar, SPh = hydrogen bonding; Sp. Gr. = specific gravity; VP = vapor pressure in mmHg at 25° C.
**See, Hansen, C. M., Hansen Solubility Parameters: A User's Handbook, Second Ed., CRC Press, Boca Raton, FL, 2007.

It should be noted that it is not possible to match the properties of the complex solvent mixture that contains multiple numbers of chemical groups—carboxyl ester, ether and aromatic to that of a single compound that contains a ketone group and carbon-carbon double bonds. Hence, one aspect of the unexpected utility of this invention lies in actual comparative testing of this solvent blend against isophorone that is illustrated in the following Examples.

### Example 2

A first set of comparative assays was for viscosity reduction for several commercially available resins—polyesters, polyacrylates and such. These assays were conducted by diluting the commercial resin by the same factor—80% resin in its solvent blend and 2% of added solvent (isophorone or solvent blend). Standard assay methods using Brookefield viscometer with specific spindles were used. The assays were carried out at room temperature (25° C.) and at several elevated temperatures. In all of the cases, the solvent blend gave consistently lower viscosities than the same test with isophorone alone. An example with a polyester resin Polymac 220-1959 available from Hexion Chemicals, Inc. is shown in Table 2, below.

TABLE 2
Comparative tests for viscosity reduction

| Polyester Resin | | |
|---|---|---|
| Polymac 220 1959 | Solvent | |
| Dilution Polymer:solvent (80:20) | Isophorone | ISR blend |
| Temperature (° F.) | Viscosity (cps) | Viscosity (cps) |
| 75° F. | 635 | 388 |
| 165° F. | 62 | 55 |
| 200° F. | 40 | 35 |
| 235° F. | 36 | 31 |
| 250° F. | 39 | 30 |
| 270° F. | 40 | 31 |

These results clearly show:

1. The solvent blend provides enhanced viscosity reduction when compared to isophorone alone.

2. The multi-component solvent blend behaves as a consistent solvent when heated and the individual components do not just volatilize independently and change the blends' solvating properties.

### Example 3

Many more comparative tests between isophorone and the solvent blends were conducted to see the behavior in actual coatings formulations. Some of these included dispersion of dyes and pigments, consistent phase behavior at a wide range of temperatures, flow characteristics, film thickness, hardness, adhesion and other properties. In all of these tests the solvent blends gave equal or superior performance compared to the isophorone-containing solvent.

### Example 4

An additional example is provided showing the formation of a single phase when both aromatic and aliphatic hydrocarbons are blended. The third portion solvent here is a mixture of the aromatic solvent A 150 as described earlier and a C₇-C₁₂ aliphatic hydrocarbon (AC) solvent 142 that is available from Hydrite Chemical Company in Cottage Grove, Wis. This C₇-C₁₂ aliphatic hydrocarbon solvent 142 is a typical Stoddard solvent containing a mixture of aliphatic hydrocarbons with a flash point>142° F. The CAS # is 64742-47-8.

A solvent blend containing (wt %) ethyl lactate (60), EEP (20), A −150 (10) and HC 142 (10) was prepared to observe phase behavior at room temperature (about 25° C.) and at ice bath (about 0° C.). In both conditions, the solvent blend remained as a single phase.

Each of the patent applications, patents and articles cited herein is incorporated by reference. The use of the article “a” or “an” is intended to include one or more.

The foregoing description and the examples are intended as illustrative and are not to be taken as limiting. Still other variations within the spirit and scope of this invention are possible and will readily present themselves to those skilled in the art.

What is claimed is:

1. A solvent composition to replace isophorone comprising three components, A, B and C, wherein component A is a C₁-C₄ lactate ester, component B is ethyl 3-ethoxy propionate and component C is a mixture of hydrocarbons each of which contains about 7 to about 12 carbon atoms and includes aromatic hydrocarbons and zero to about 70 weight percent aliphatic hydrocarbons, wherein each of said components A, B and C is present at about 10 to about 80 weight percent of the total solvent composition, said solvent composition being a homogeneous liquid at zero degrees C.

2. The solvent composition according to claim 1, wherein said mixture of C₇-C₁₂ hydrocarbons has a distillation range of about 150° to about 230° C. at one atmosphere, and a Tagliabue (Tag) closed cup (TCC) flash point of about 100° F. or greater.

3. The solvent composition according to claim 1, wherein the C₁-C₄ lactate ester comprises about 50 to about 80 weight percent of the said composition.

4. The solvent composition according to claim 3, wherein the C₁-C₄ lactate ester comprises up to about 75 weight percent of the said composition.

5. The solvent composition according to claim 1, wherein the C₁-C₄ lactate ester is ethyl lactate.

6. The solvent composition according to claim 1, wherein component C is a solvent mixture of C₇-C₁₂ aromatic hydrocarbons.

7. The solvent composition according to claim 1, wherein component C is a solvent mixture of both C₇-C₁₂ aromatic hydrocarbons and C₇-C₁₂ aliphatic hydrocarbons.

8. The solvent composition according to claim 7, wherein component C contains about equal weights of both C₇-C₁₂ aliphatic and C₇-C₁₂ aromatic hydrocarbons.

9. A solvent composition to replace isophorone comprising three components, A, B and C, wherein component A is ethyl lactate, component B is ethyl 3-ethoxy propionate and component C is a mixture of hydrocarbons each of which contains about 7 to about 12 carbon atoms,
said mixture of C₇-C₁₂ hydrocarbons having:
a) a distillation range of about 150° to about 230° C. at one atmosphere,
b) aromatic hydrocarbons and zero to about 70 weight percent aliphatic hydrocarbons, and
c) a Tagliabue (Tag) closed cup (TCC) flash point of about 100° F. or greater,
wherein each of said components A, B and C is present at about 10 to about 80 weight percent of the total solvent composition, said solvent composition being a homogeneous liquid at zero degrees C.

10. The solvent composition according to claim 9, wherein ethyl lactate is present at about 50 to about 70 weight percent, ethyl 3-ethoxy propionate is present at about 15 to about 35 weight percent, and the C₇-C₁₂ hydrocarbon mixture constitutes about 15 to about 35 percent.

11. The solvent composition according to claim 10, wherein each of the three ingredients is present in a weight ratio of about 3:1:1.

12. The solvent composition according to claim 10, wherein the C₇-C₁₂ hydrocarbon mixture is substantially only aromatics.

13. The solvent composition according to claim 10, wherein the C₇-C₁₂ hydrocarbon mixture contains aromatic and aliphatic hydrocarbons.

14. The solvent composition according to claim 13, wherein the C₇-C₁₂ hydrocarbon mixture contains aromatic and aliphatic hydrocarbons in approximately equal amounts by weight.

15. The solvent composition according to claim 10, wherein the C₇-C₁₂ hydrocarbon mixture has a TCC flash point greater than 150° F.
